(19) United States
(12) Patent Application Publication
(10) Pub. No.: US 2011/0005216 A1
(43) Pub. Date: Jan. 13, 2011

(54) VARIABLE DISPLACEMENT TORQUE CONVERTER

(75) Inventors: Toshiya Yamashita, Toyota-shi (JP); Atsushi Honda, Seto-shi (JP); Hirofumi Ota, Toyota-shi (JP)

Correspondence Address: SUGHRUE MION, PLLC, 2100 PENNSYLVANIA AVENUE, N.W., SUITE 800, WASHINGTON, DC, 20037, US

(73) Assignee: Toyota Jidosha Kabushiki Kaisha, Toyota-shi (JP)

(21) Appl. No.: 12/922,149

(22) PCT Filed: Mar. 9, 2009
(86) PCT No.: PCT/JP2009/054470

§ 371 Date: Sep. 10, 2010

(30) Foreign Application Priority Data
Mar. 13, 2008 (JP) 2008-064385

(51) Int. Cl. F16D 33/02

(52) U.S. Cl. 60/347

(57) ABSTRACT

A variable displacement torque converter having a pump wheel rotatably driven to generate a flow of fluid, a turbine wheel rotated in response to the flow of fluid delivered from the pump wheel, and a stator wheel rotatably disposed in the flow of fluid from the turbine wheel to the pump wheel, the variable displacement torque converter includes an electric motor rotatably driving the stator wheel for adjusting an output torque to be output from the turbine wheel.

### TECHNICAL FIELD

The present invention relates to torque converters through which torque, output from a drive source, is transferred by means of fluid and, more particularly, to a variable displacement torque converter capable of altering a torque multiplication rate.

### BACKGROUND ART

One kind of fluid power transmissions has heretofore been known as a torque converter that includes a pump wheel rotatably driven with an internal combustion engine to generate a flow of fluid, a turbine wheel rotated due to the flow of fluid delivered from the pump wheel, and a stator wheel rotatably disposed in the flow of fluid between the turbine wheel and the pump wheel. With such a torque converter, the stator wheel is connected to a non-rotating member via a one-way clutch and no variable displacement characteristic is provided. In general, the torque converter has a fluid characteristic that is required to have a high displacement capacity (capacity coefficient) with directivity for fuel economy performance and a low displacement capacity (capacity coefficient) with directivity for acceleration. With such a related art structure, the fluid characteristic is uniquely determined with shapes of the pump wheel, the turbine wheel and the stator wheel. Therefore, the torque converter exhibits identical fluid characteristics regardless of running patterns, resulting in limitations caused in improving fuel economy performance and power performance at once.

As disclosed in Patent Publication 1, on the contrary, a variable displacement torque converter is proposed incorporating brake means between a stator and a non-rotating member, under which brake torque of the braking means is adjusted to allow a displacement capacity to be variable. With such a structure, using the braking means to adjust brake torque results in a capability of causing a torque ratio and a capacity coefficient of the torque converter to vary in a stepless mode or a multi-stage mode. This enables an optimum torque ratio and capacity coefficient to be determined depending on a driving condition and a running condition, enabling a vehicle to have increased running performance.

Patent Publication 1: Japanese Patent Application Publication No. 1-169170

### DISCLOSURE OF THE INVENTION

### Issues to be Addressed by the Invention

With the variable displacement torque converter of such a related art, however, the rotation of the stator wheel is merely controlled in a range of a negative direction of rotation opposite to a rotational direction of the pump wheel, resulting in limitations in an upper limit value of the resulting torque ratio and a lower limit value of the resulting capacity coefficient. Thus, the torque ratio of the torque converter cannot be necessarily and adequately increased and the capacity coefficient cannot be varied to be low depending on the driving condition and the running condition. Thus, it is difficult for the vehicle to have adequately increased power performance.

### SUMMARY OF THE INVENTION

The present invention has been completed with the above views in mind and has an object to provide a variable displacement torque converter that can vary a torque ratio at a higher level and a capacity coefficient at a lower level with a vehicle having an adequate increase in power performance.

### Means for Addressing the Issues

Upon various studies conducted by the present inventors with the above views in mind, it turned out that a higher torque ratio and a lower capacity coefficient than those attained in the related art can be obtained. This is accomplished by actively driving the stator wheel in a positive direction of rotation in conformity to the rotational direction of the pump wheel with the use of an electric motor that plays a role as a drive-force source independently of the drive-force source of the vehicle. The present invention has been completed on the ground of such finding.

The object indicated above can be achieved according to a first mode of the invention, which provides a pump wheel rotatably driven to generate a flow of fluid, a turbine wheel rotated in response to the flow of fluid delivered from the pump wheel, and a stator wheel rotatably disposed in the flow of fluid from the turbine wheel to the pump wheel, the variable displacement torque converter comprising: an electric motor rotatably driving the stator wheel for adjusting an output torque to be output from the turbine wheel.

The object indicated above can be achieved according to a second mode of the invention, which provides the variable displacement torque converter of the first mode of the invention, further including a clutch connectable between the electric motor and the stator wheel.

The object indicated above can be achieved according to the third mode of the invention, which provides the variable displacement torque converter of the first or second mode of the invention, further including a brake connectable between the stator wheel and a non-rotating member.

The object indicated above can be achieved according to the fourth mode of the invention, which provides the variable displacement torque converter of any one of the first through third modes of the invention, wherein the electric motor causes the stator wheel to rotate in a positive direction of rotation in conformity to a rotational direction of the pump wheel so that a torque multiplying ratio is increased.

The object indicated above can be achieved according to the fifth mode of the invention, which provides the variable displacement torque converter of any one of the first through forth modes of the invention, wherein the electric motor performs regeneration to cause the stator wheel to rotate in a negative direction of rotation opposite to the rotational direction of the pump wheel so that a torque multiplying ratio is decreased.

The object indicated above can be achieved according to the sixth mode of the invention, which provides the variable displacement torque converter of the third mode of the invention, wherein the brake is caused to slip to allow the stator wheel to rotate in the negative direction of rotation opposite to the rotational direction of the pump wheel.

The object indicated above can be achieved according to the seventh mode of the invention, which provides the variable displacement torque converter of the second or third mode of the invention, further including a one-way clutch disposed between the stator wheel and the clutch or the brake for permitting the stator wheel to rotate in a positive direction of rotation in conformity to the rotational direction of the pump wheel but blocking the stator wheel from rotating in a negative direction of rotation opposite to the rotational direction of the pump wheel.

The variable displacement torque converter recited in claim 1 includes the motor that drivably rotates the stator wheel for the purpose of adjusting output torque delivered from the turbine wheel. By using the motor to actively drive the stator wheel to rotate in the positive direction of rotation in conformity to the rotational direction of the pump wheel, it becomes possible to have a higher torque ration and a lower capacity coefficient than those attained in the related art. In addition, using the motor to rotate the stator wheel in the positive direction of rotation in conformity to the rotational direction of the pump wheel and in the negative direction of rotation opposite to the rotational direction of the pump wheel allows the torque ratio and the capacity coefficient to have wider varying ranges than those attained in the related art. This allows the vehicle to have remarkably improved fuel economy performance and power performance.

The variable displacement torque converter recited in claim 2 further includes the clutch operative to provide a connection between the motor and the stator wheel. This allows the clutch to usually engage while causing the clutch to slip when applied with rapid torque. This protects the motor or the stator wheel controllably rotated therewith. In addition, the clutch is caused to disengage during the failure of the motor or during the moment needed to suppress the load of the motor in the presence of limited charging and discharging or heat generation. This enables the motor to be disconnected from the motor wheel.

The variable displacement torque converter recited in claim 3 further includes the brake capable of providing a connection between the stator wheel and non-rotating member. By operatively causing the brake to engage, the stator wheel can be applied with reaction force without using the motor during the failure of the motor or during the moment needed to suppress the load of the motor in the presence of limited charging and discharging or heat generation.

According to the variable displacement torque converter recited in claim 4, the motor causes the stator wheel to rotate in the positive direction of rotation in conformity to the rotational direction of the pump wheel with a resultant increase in the torque multiplying ratio. Thus, it becomes possible to have higher torque ratio and lower capacity coefficient than those attained in the related art.

According to the variable displacement torque converter recited in claim 5, the motor has the regenerative effect to rotate the stator wheel in the negative direction of rotation opposite to the rotational direction of the pump wheel with a resultant decrease in the torque multiplying ratio. This allows wider varying ranges to be obtained for the torque ratio to a decreasing side and for the capacity coefficient to an increasing side. This enables the vehicle to have further remarkably increased fuel economy performance and power performance.

According to the variable displacement torque converter recited in claim 6, the brake is caused to slip such that the stator wheel rotates in the negative direction of rotation opposite to the rotational direction of the pump wheel with a resultant decrease in torque multiplying ratio. This results in wider varying ranges for the torque ratio to a decreasing side and for the capacity coefficient for an increasing side. This enables the vehicle to have further remarkably increased fuel economy performance and power performance.

According to the variable displacement torque converter recited in claim 7, the one-way clutch is disposed between the stator wheel and the clutch or the brake. This allows the stator wheel to rotate in the positive direction of rotation in conformity to the rotational direction of the pump wheel but blocks the stator wheel from rotating in the negative direction of rotation opposite to the rotational direction of the pump wheel. This results in an effect of obtaining a certain torque converter characteristic like that of a fixed-displacement torque converter of the related art even during the failure of the motor or during the moment needed to suppress the load of the motor in the presence of limited charging and discharging or hear generation.

Here, the variable displacement torque converter of the present invention may be applied to a vehicle or the like having an engine such as an internal combustion engine or the like as a drive-force source.

The variable displacement torque converter of the present invention is not limited in application to a vehicle provided with a step-variable automatic transmission as a power transfer device but may be applied to a vehicle or the like provided with power transfer devices of other type such as, for instance, a manual transmission and a continuously variable transmission (CVT) or the like.

### BRIEF DESCRIPTION OF THE DRAWINGS

FIG. 1 is a skeleton view of a structure of a vehicular power transfer device to which the present invention is applied.

FIG. 2 is a view showing the relationships between a drive current and drive torque or between a generated current and brake torque of an electric motor of the torque converter shown in FIG. 1.

FIG. 3 is an operation table illustrating combined operations to be executed by hydraulically operated frictional engaging devices (elements) when an automatic transmission shown in FIG. 1 establishes a plurality of gear positions (shifting gear stages).

FIG. 4 is a circuit diagram, related to linear solenoid valves or the like arranged to control the operations of various hydraulic actuators for clutches and brakes of the automatic transmission shown in FIG. 1, and represents the circuit diagram to show a part of a hydraulic control circuit.

FIG. 5 is a cross-sectional view illustrating a structure of the linear solenoid valve shown in FIG. 5.

FIG. 6 is a view showing the relationship between a drive current supplied to the linear solenoid valve, shown in FIG. 5, and an output hydraulic pressure output from the linear solenoid valve.

FIG. 7 is a block diagram illustrating major parts of a control system incorporated in a vehicle for controlling an engine, the automatic transmission and the torque converter shown in FIG. 1.

FIG. 8 is a view showing cross-sectional shapes of blades of a pump wheel, a turbine wheel and a stator wheel in a deployment along stream lines thereof forming the torque converter shown in FIG. 1.

FIG. 9 is a view showing the characteristic of the torque converter, shown in FIG. 1, and representing a torque ratio of the torque converter versus a speed ratio thereof.

FIG. 10 is a view showing the characteristics of the torque converter, shown in FIG. 1, and a capacity coefficient plotted in terms of the speed ratio.

FIG. 11 is a skeleton view illustrating a structure of a torque converter of another embodiment to which the present invention is applied.

FIG. 12 is a skeleton view illustrating a structure of a torque converter of another embodiment to which the present invention is applied.

FIG. 13 is a skeleton view illustrating a structure of a torque converter of another embodiment to which the present invention is applied.

FIG. 14 is a skeleton view illustrating a structure of a torque converter of another embodiment to which the present invention is applied.

### REFERENCE SIGNS LIST

6,116,118,120,122: torque converter
6p: pump wheel
6t: turbine wheel
6s: stator wheel
10: electric motor
11: transmission case (case)
B0-B2: brake (hydraulically operated frictional engaging device)
C: capacity coefficient (=T_{P}/N_{P}²)
C0-C4: clutch (hydraulically operated frictional engaging device)
F0, F1: one-way clutch
N_{P}: pump revolution (rotational speed)
N_{T}: turbine revolution (rotational speed)
T_{P}: pump torque (engine torque)
T_{T}: turbine torque (output torque)
e: speed ratio (=N_{T}/N_{P})
t: torque ratio (torque multiplication ratio, =T_{T}/T_{P})

### BEST MODE FOR CARRYING OUT THE INVENTION

Now, one embodiment of the present invention will be described below in detail with reference to the accompanying drawings. In the following embodiments, some figures are simplified or modified, and dimensional ratios or shapes of the portions in the figures are not necessarily described accurately.

### Embodiment

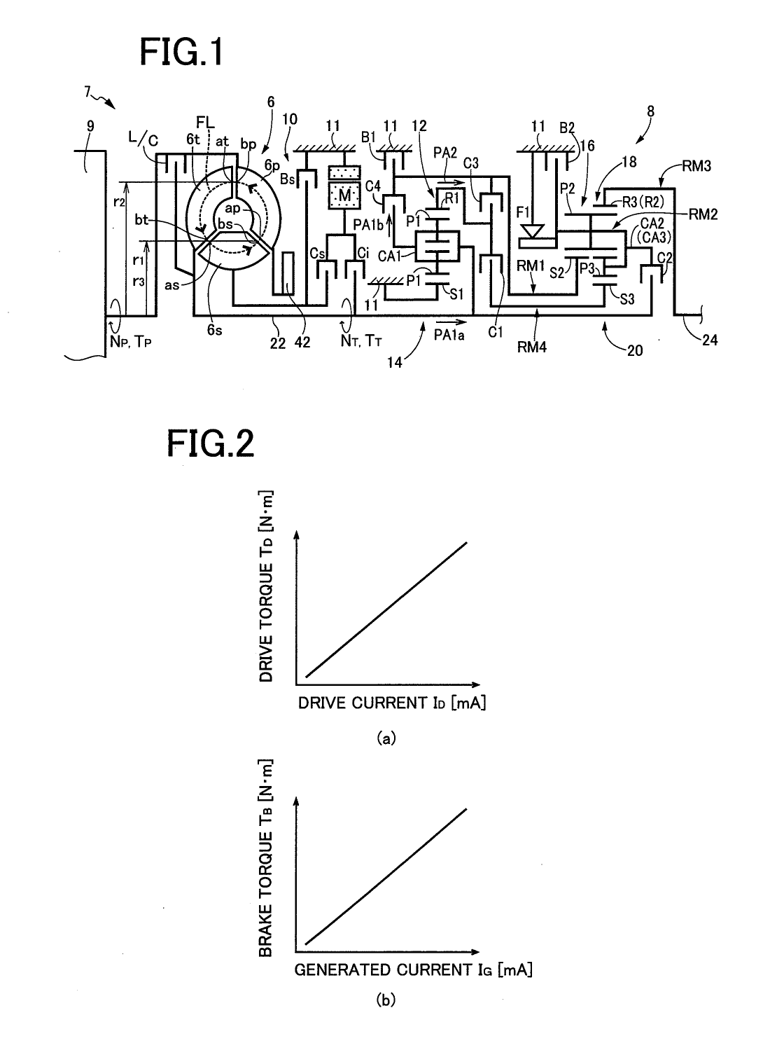

FIG. 1 is a skeleton view of a vehicular power transfer device 7 to which a torque converter 6 (variable displacement type torque converter) of one embodiment according to the present invention is applied. The vehicular power transfer device 7 is of the type, including the torque converter 6 and an automatic transmission 8 of a longitudinal layout and preferably applied to an FR (front engine rear drive) type vehicle which includes an engine 9 as a drive-force source for run. The engine 9, comprised of an internal combustion engine, provides an output that is transferred through the torque converter 6 functioning as a hydraulic power transfer device, the automatic transmission 8, a differential gear device (final speed reduction gear) that is not shown, and a pair of axles, etc., to left and right drive wheels.

The torque converter 6 includes a pump wheel 6p connected to a crankshaft of the engine 9 to be rotatably driven by the engine 9 to generate a fluid flow due to working oil flowing through the torque converter 6, a turbine wheel 6t connected to an input shaft 22 of the automatic transmission 8 to be rotated upon receipt of the fluid flow delivered from the pump wheel 6p, and a stator wheel 6s rotatably disposed in a fluid steam delivered from the turbine wheel 6t to the pump wheel 6p. Thus, the torque converter 6 is arranged to perform a power transfer by means of working oil (fluid).

Further, a lock-up clutch L/C is interposed between the pump wheel 6p and the turbine wheel 6t to allow a hydraulic control circuit 30, described later, to controllably place the lock-up clutch L/C in an engine state, a slipping state or a disengaging state. With the lock-up clutch L/C placed in a completely engaging state, the pump wheel 6p and the turbine wheel 6t are caused to unitarily rotate, i.e., in a direct connection between the crankshaft of the engine 9 and the input shaft 22 of the automatic transmission 8.

The torque converter 6 includes an electric motor (motor) 10 for rotatably driving the stator wheel 6s, a clutch C0 disposed between the motor 10 and the stator wheel 6s and operable to connect the electric motor 10 and the stator wheel 6s to and from each other, and a brake B0 disposed between the stator wheel 6s and a transmission case (hereinafter referred to as a “case”) 11 serving as a non-rotating member and operable to provide connection between the stator wheel 6s and the case 11. Moreover, a one-way clutch F0 is disposed between the stator wheel 6s and the clutch C0 or the brake B0 to block the rotation of the stator wheel 6s in a negative direction of rotation opposite to the rotational direction of the pump wheel 6p while permitting the stator wheel 6s to rotate in the positive direction of rotation in conformity to the rotational direction of the pump wheel 6p.

With the brake B0 caused to be disengaged and the clutch C0 caused to be engaged, the electric motor 10 drives the stator wheel 6s so as to control a revolution of the stator wheel 6s in a positive rotating direction in agreement with a rotating direction of the pump wheel 6p. In this moment, the stator wheel 6s is applied with drive torque T_{D} to rotate in the positive rotating direction at a rate proportionate to the magnitude of a drive current I_{D} supplied to the electric motor 10 from an electric control circuit 78 for rotatably driving the same in a manner, for instance, as shown in FIG. 2 (a) as will be described below. Further, the electric motor 10 drives the stator wheel 6s so as to control the revolution of the stator wheel 6s in the negative rotating direction. During such control, the stator wheel 6s is applied with drive torque T_{D} to rotate in the negative rotating direction at a rate proportionate to the magnitude of, for instance, the drive current I_{D} supplied to the electric motor 10 from the electric control device 78.

Further, with the brake B0 caused to be released and the clutch C0 caused to be engaged, the electric motor 10 is also arranged to control the revolution of the stator wheel 6s in the negative rotating direction opposite to the rotating direction of the pump wheel 6p by means of a regenerative (power generation) effect upon receipt of the fluid flow delivered from the stator wheel 6s. During such control, the stator wheel 6s is applied with load torque, i.e., brake torque T_{B}, in the negative rotating direction at a rate proportionate to the magnitude of, for instance, a generated current I_{G} supplied to or stored in a battery or the like mounted on, for instance, a vehicle in a manner as shown in FIG. 2 (b).

The clutches C0 and the brake B0 are hydraulically operated friction engaging devices, including multi-disc type clutches or brakes, each of which is brought into frictional engagement or disengagement due to an associated hydraulic actuator and a hydraulic pressure applied thereto. With the brake B0 caused to be completely engaged, the stator wheel 6s is fixedly secured to the case 11 via the one-way clutch F0 to be rendered non-rotatable in the negative rotating direction opposite to the positive rotating direction of pump wheel 6p. Even with a slippage occurring when adjusting the degree of engagement, i.e., an engaging pressure, of the brake B0, the stator wheel 6s is arranged to rotate in the negative rotating direction opposite to the positive rotating direction of the pump wheel 6p in a relative effect. In this moment, the stator wheel 6s is applied with load torque, i.e., brake torque T_{B}, in the negative rotating direction at a rate increasing with an increase in, for instance, the engaging pressure. Upon engagement of the clutch C0, further, the stator wheel 6s is applied with drive torque T_{D} or brake torque T_{B} intact from the electric motor 10. Moreover, due to the slippage of the clutch C0 occurring when adjusting the degree of engagement, i.e., the engaging pressure of the clutch C0, a transfer rate of drive torque T_{D} or brake torque T_{B} is caused to vary depending on the magnitude of the relevant engaging pressure of the clutch C0.

The automatic transmission 8 includes a first shifting portion 14, mainly comprised of a first planetary gear set 12 of a double pinion type, and a second shifting portion 20 mainly comprised of a second planetary gear set 16 of a single pinion type and a third planetary gear set 18 of a double pinion type, which are incorporated on a common axis in the case 11 mounted on a vehicle body as a non-rotating member. This allows the rotation of the input shaft 22 to shift in speed to be output from an output shaft 24. The input shaft 22 also acts as a turbine shaft of the torque converter 6 that is rotatably driven with the drive force delivered from the engine 9 serving as the drive-force source for run. In addition, the torque converter 6 and the automatic transmission 8 take the form of nearly symmetric structures with respect to their center axes and, hence, lower halves of these structures are herein omitted from the skeleton view of FIG. 1.

The first planetary gear set 12 includes a sun gear S1, pinion gears P1 held in meshing engagement with each other in pairs, a carrier CA1 supporting the pinion gears P1 to be rotatable about their axes and about the axis of the sun gear S1, and a ring gear R1 held in meshing engagement with the sun gear S1 via the pinion gears P1. Likewise, the second planetary gear set 16 includes a sun gear S2, pinion gears P2, a carrier CA2 supporting the pinion gears P2 to be rotatable about their axes and about the axis of the sun gear S2, and a ring gear R2 held in meshing engagement with the sun gear S2 via the pinion gears P2. In addition, the third planetary gear set 18 includes a sun gear S3, pinion gears P2 and P3 held in meshing engagement with each other in pairs, a carrier CA3 supporting the pinion gears P2 and P3 to be rotatable about their axes and about the axis of the sun gear S3, and a ring gear R3 held in meshing engagement with the sun gear S3 through the pinion gears P2 and P3.

In FIG. 1, clutches C1 to C4 and brakes B1 and B2 are hydraulically operated friction engaging devices such as multi-disc type clutches or brakes, respectively, like those of the clutches C0 and the brake B0, each of which is caused to engage or disengage by a hydraulic actuator and a hydraulic pressure applied thereto. A first rotary element RM1 (sun gear S2) is selectively coupled to the case 11 via the first brake B1 to halt in rotation and selectively coupled to the ring gear R1 (i.e., a second intermediate output pathway PA2) of the first planetary gear set 12 in the form of an intermediate output member via the third clutch C3. The first rotary element RM1 is also selectively coupled to the carrier CA1 (i.e., an indirect pathway PA1b of a first intermediate output path PA1) of the first planetary gear set 12 via the fourth clutch C4.

Further, a second rotary element RM2 (carriers CA2 and CA3) is selectively coupled to the case 11 via the second brake B2 to halt in rotation and selectively coupled to the input shaft 22 (i.e., a directly connected pathway PA1a of the first intermediate output pathway PA1) via the second clutch C2. Furthermore, a third rotary element RM3 (ring gears R2 and R3) is integrally connected to the output shaft 24 to output the rotation of the third rotary element RM3. Moreover, a fourth rotary element RM4 (sun gear S3) is connected to the ring gear R1 via the first clutch C1. In addition, a one-way clutch F1 is interposed between the second rotary element RM2 and the case 11 in parallel to the second brake B2 for permitting the second rotary element RM2 in a positive rotating direction (in agreement with the rotating direction of the input shaft 22) while blocking a reverse rotation of the second rotary element RM2.

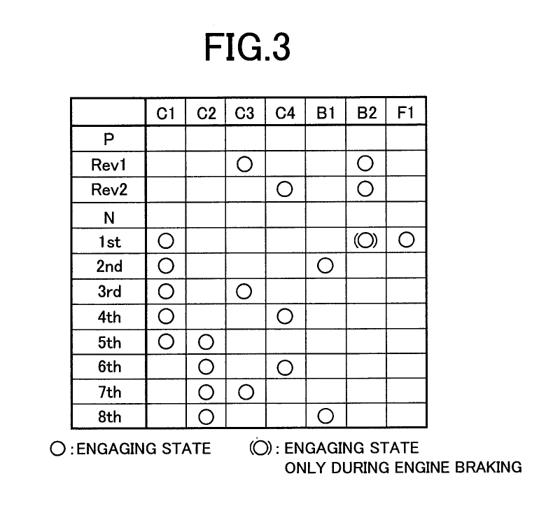

FIG. 3 is a table illustrating operating states of the various engaging elements used for establishing various gear positions in the automatic transmission 8 with a symbol “o” representing an engaging state and a symbol “(o)” representing an engaging state established only during engine braking while a blank state represents a disengaging state. As shown in FIG. 3, the automatic transmission 8 of the present embodiment is arranged to establish each of a plurality of gear positions including forward-drive 8 gear positions different in speed ratio (=an input-shaft rotation speed N_{IN} of the automatic transmission 8 versus an output-shaft rotation speed N_{OUT} of the automatic transmission 8). This is achieved by causing the various engaging devices, i.e., a plurality of hydraulically operated friction engaging devices (clutches C1 to C4 and brakes B1 and B2) to be selectively engaged. In addition, the various gear positions have speed ratios that are properly determined with various gear ratios ρ1, ρ2 and ρ3 of the first planetary gear set 12, the second planetary gear set 16 and the third planetary gear set 18.

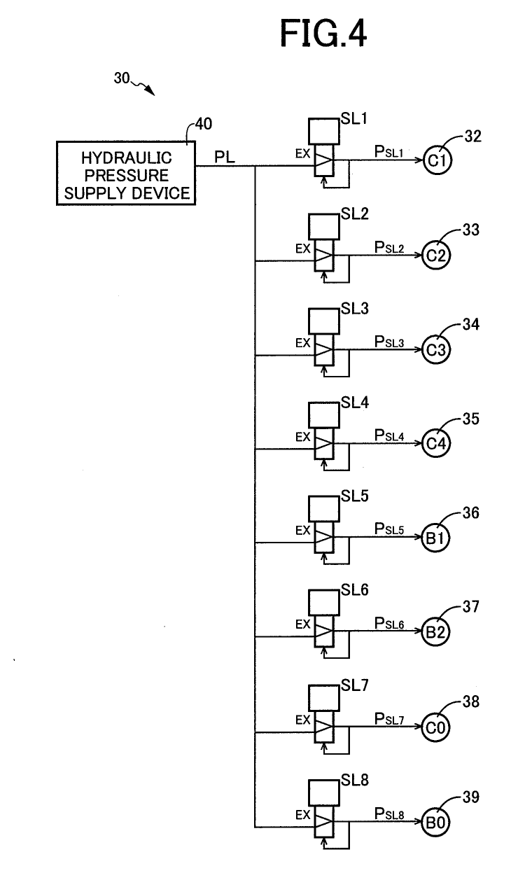

FIG. 4 is a circuit diagram representing a hydraulic control circuit 30, operative to supply hydraulic pressures to clutches C0 to C4 and brakes B0 to B2 (which will be herein described as a clutch C and a brake B unless otherwise particularly differentiated) which form the plurality of hydraulically operated frictional engaging devices, in respect of sections to control the hydraulic pressures to be supplied to the plurality of hydraulically operated frictional engaging devices. As shown in FIG. 4, the hydraulic control circuit 30 of the present embodiment has linear solenoid valves SL1, SL2, SL3, SL4, SL5, SL6, SL7 and SL8 (which will be herein described as “SL” unless otherwise particularly differentiated) individually provided for hydraulic actuators (hydraulic cylinders) 32, 33, 34, 35, 36, 37, 38 and 39 of the clutches C0 to C4 and the brakes B0 to B2, respectively. The original pressure, e.g., the line pressure PL, output from the hydraulic pressure supply device 40, are individually regulated by those linear solenoid valves SL and supplied to the hydraulic actuators 32 to 39, respectively.

The hydraulic pressure supply device 40 includes a solenoid valve energized by an electronic control device 78, described later, for opening or closing hydraulic passages, a linear solenoid valve performing hydraulic pressure control, an opening/closing valve for opening or closing the hydraulic passages or performing hydraulic pressure control in accordance with signal pressures output from the solenoid valve and the linear solenoid valve, and a pressure regulator valve or the like. This allows the line pressure PL to be regulated based on the hydraulic pressure generated by the mechanical type hydraulic pump 42 (see FIG. 1) that is rotatably driven with the engine 9.

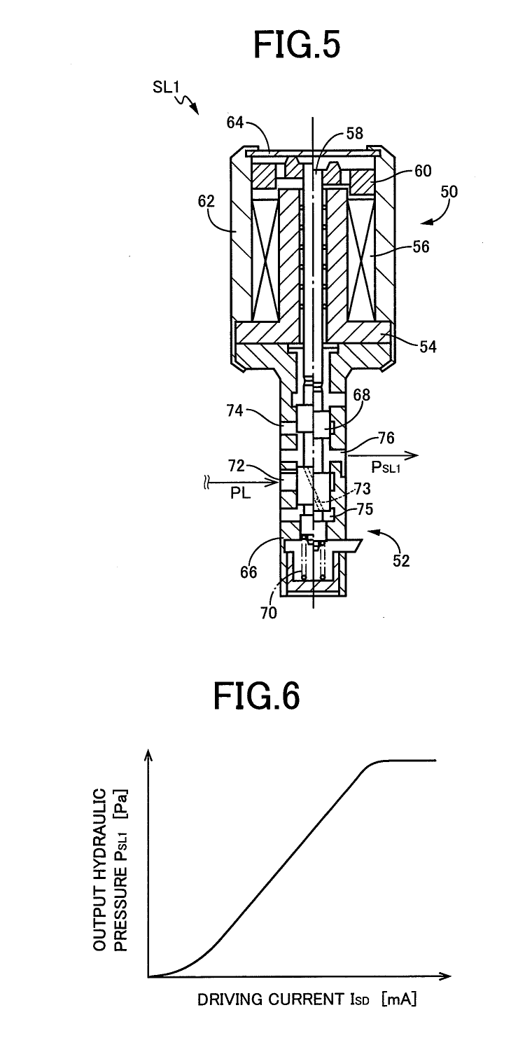

FIG. 5 is a cross-sectional view illustrating a structure of the linear solenoid valve SL. Here, since the linear solenoid valves SL1 to SL8, incorporated in the hydraulic control circuit 30 in the present embodiment basically take the same structures, the linear solenoid valve SL1 is exemplarily shown in FIG. 5. The linear solenoid valve SL1 includes a solenoid 50, serving as a device to convert electric energy to driving force when conducted, and a pressure regulating section 52 for regulating the line pressure PL based on the original pressure to generate a predetermined output hydraulic pressure P_{SL1} when driven by the solenoid 50.

The solenoid 50 includes a cylindrical winding core 54, a coil 56 wound on an outer periphery of the winding core 54, a core 58 disposed inside the winding core 54 to be axially moveable, an iron 60 fixedly mounted on the core 58 at an end portion thereof in opposition to the pressure regulating section 52, a bottomed cylindrical yoke 62 encompassing the winding core 54, the coil 56, the core 58 and the iron 60, and a cover 64 fitted to the opening of the yoke 62. The pressure regulating section 52 includes a sleeve 66 fitted to the yoke 62, a valve element 68 disposed in the sleeve 66 to be axially moveable to open or close an inlet port 72 and an outlet port 76, and a spring 70 urging the valve element 68 in a direction toward the solenoid 50, i.e., in a valve-closing direction. The valve element 68 has an end portion, closer to the solenoid 50, is held in abutting engagement with an end portion of the core 58 in an area near the pressure regulating section 52.

Assume that a solenoid thrust, proportional to the driving current I_{SD} for urging the valve element 68 in a valve-opening direction via the core 58 in response to the driving current I_{SD} applied to the coil 56, is F_{SOL}; a spring force of the spring 70 for urging the valve element 68 in the valve-closing direction is F_{S}; and a feedback thrust operative to urge the valve element 68 in the valve-closing direction and represented by a product between the output hydraulic pressure P_{SL1}, supplied to a hydraulic chamber 75 via a flow passage 73 formed in the valve element 68, and a differential surface area of the valve element 68 in the hydraulic chamber 75 in respect of the axial direction of the valve element 68 is F_{F}. Then, the valve element 68 is actuated to provide a balance in an equation indicated below.

F_{SOL}=F_{S}+F_{F} (1)

Therefore, the linear solenoid SL1 regulates the flow amount of working oil admitted from the inlet port 72 depending on a moving position of the valve element 68 in the valve-opening direction or the valve/closing direction, i.e., an actuated position thereof and the flow amount of working oil discharged from a drain port 74. Then, the line pressure PL, input from the inlet port 72, is regulated at the predetermined output hydraulic pressure P_{SL1} depending on the drive current I_{SD}, in accordance with the characteristic representing the relationship between the drive current I_{SD} and the output hydraulic pressure P_{SL1} as shown, for instance, in FIG. 6, such that the output hydraulic pressure P_{SL1} is output from the outlet port 76.

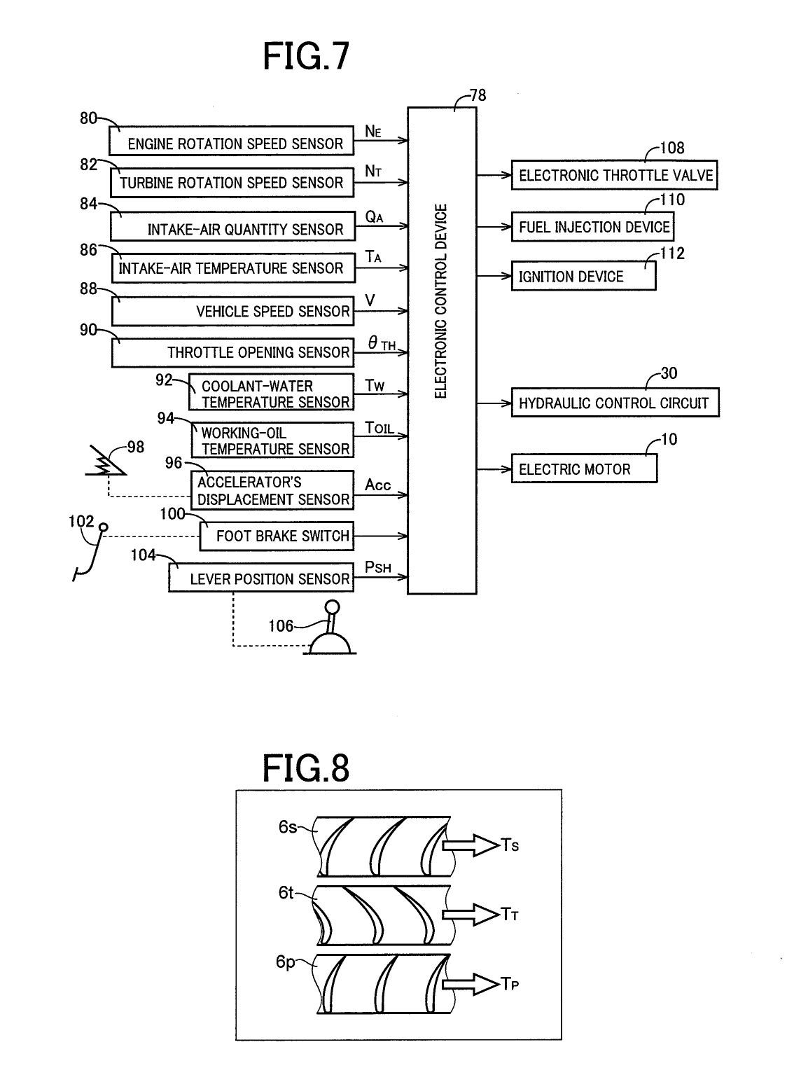

FIG. 7 is a block diagram illustrating a control system provided on the vehicle for controlling the engine 9, the automatic transmission 8 or the torque converter 6, etc. in FIG. 1. The electronic control device 78 is supplied with signals including: a signal representing an engine rotation speed N_{E} delivered from an engine rotation speed sensor 80; a signal representing a turbine rotation speed N_{T}, i.e., an input-shaft rotation speed N_{IN}, delivered from a turbine rotation speed sensor 82; a signal representing an intake air quantity Q_{A} delivered from an intake-air quantity sensor 84; a signal representing an intake-air temperature T_{A} delivered from an intake-air temperature sensor 86; a signal representing a vehicle speed V, i.e., an output-shaft rotation speed N_{OUT}, delivered from a vehicle speed sensor 88; a signal representing a throttle valve opening θ_{TH} delivered from a throttle opening sensor 90; a signal representing a coolant-water temperature T_{W} delivered from a coolant-water temperature sensor 92; a signal representing a working-oil temperature T_{OIL} of a hydraulic control circuit 30 delivered from a working-oil temperature sensor 94; a signal representing an operated value Acc of an accelerator operation member such as an accelerator pedal 98 or the like delivered from an accelerator's displacement sensor 96; a signal representing the presence or absence of a foot brake 102 in the form of a normal-use brake being operated and delivered from a foot brake switch 100; and a signal representing a lever position (operated position) P_{SH} of a shift lever 106 delivered from a lever position sensor 104, etc.

The electronic control device 78 includes a so-called microcomputer composed of CPU, RAM, ROM and input/output interfaces, etc. The CPU processes various input signals in accordance with programs preliminarily stored in ROM while utilizing a temporary storage function of RAM to output signals, i.e., output signals to an electronic throttle valve 108, a fuel injection device 110, an ignition device 112, linear solenoid valves, etc., of the hydraulic control circuit 30 or the electric motor 10, etc. The electronic control device 78 has a structure arranged to perform such input/output signal processing to execute output control of the engine 9, shift control of the automatic transmission 8 or rotation control of the stator wheel 6s of the torque converter 6, etc. Thus, the electronic control device 78 is divided in structure for engine control and shift control depending on needs.

With the present embodiment, the output control of the engine 9 is accomplished with the electronic throttle valve 108, the fuel injection device 110 and the ignition device 112, etc.

The shift control of the automatic transmission 8 is accomplished with the hydraulic control circuit 30. For instance, a gear position to be shifted in the automatic transmission 8 is determined based on an actual throttle valve opening θ_{TH} or an operated value of the accelerator operation member Acc and vehicle speed V by referring to a preliminarily stored shifting diagram (shifting map) including a plurality of the shifting lines defined in a two dimensional frame of reference which represents a vehicle speed axis and a throttle valve opening value axis or an accelerator opening value axis. And the clutch C1 to C4 and the brakes B1 and B2 are switched to engaging or disengaging states in accordance with the operation table shown in FIG. 3 so as to establish the determined gear position. The engaging or disengaging states of the clutch C and the brake B are switched by continuously controlling the engaging pressures of the clutch C and the brake B through control of the drive current I_{SD} applied to the linear solenoid valve SL of the hydraulic control circuit 30. This prevents the occurrence of a shifting shock due to fluctuation in drive force or deterioration in durability of friction material. In addition, the shifting control may be possible to be implemented in various modes based on a throttle valve opening θ_{TH}, an intake air quantity Q_{A} and a road gradient or the like.

The torque converter 6 performs the rotation control of the stator wheel 6s using the clutch C0 and the brake B0 of the hydraulic control circuit 30 and/or the electric motor 10. In particular, the rotation control of the stator wheel 6s is accomplished by suitably adjusting drive torque T_{D} at a rate proportionate to the magnitude of the drive current I_{D} supplied to the electric motor 10 from the inverter (not shown) in accordance with a command from the electronic control device 78, or brake torque T_{B} at a rate proportionate to, for instance, the magnitude of the generated-current I_{G} output from the electric motor 10.

With the torque converter 6 of the present embodiment, working oil, stick onto an outer circumferential area due to a centrifugal force, circulates through the pump wheel 6p, the turbine wheel 6t and the stator wheel 6s in this order in a cross section of the torque converter 6 so as to move along a streamline FL shown in FIG. 1. As shown in FIG. 8, the pump wheel 6p, the turbine wheel 6t and the stator wheel 6s include pluralities of vanes spaced by fixed intervals along a circumferential direction, respectively. FIG. 8 represents the vanes with shapes formed along the streamline FL of working oil filled in the torque converter 6 in each wheel. Working oil, applied with energy from the vanes of the pump wheel 6p to flow, acts on the vanes of the turbine wheel 6t to rotate the same. Working oil, passing across the turbine wheel 6t, impinges upon the vanes of the stator wheel 6s to turn in direction in a converter region, after which working oil is circulated to the pump wheel 6p. With working oil impinged upon the vanes of the stator wheel 6s to turn in direction, the stator wheel 6s generates reactive torque. This reactive torque corresponds to a direction converting rate (angle) of working oil and is associated with the magnitude of a torque ratio “t” that will be described later.

According to a definition of angular momentum, torque T [N·m], applied to working oil (fluid) from the various wheels (the pump wheel 6p, the turbine wheel 6t and the stator wheel 6s), is given by equation (2) as expressed below.

T=(γ/g)×Q×Δ(r×v_{U}) Eq. (2)

In equation (2), “γ” is a weight volume ratio [kg/m³] of working oil prevailing in the torque converter 6; “g” is a gravitational acceleration [m/s²]; “Q” is a volumetric flow amount [m³/s]; and “Δ(r×v_{U})” is a difference in momentums “r×v_{U}” [m²/s] of fluid flows of working oil with absolute velocities at an outlet and an inlet of each wheel.

From equation (2), torque T₁ [N·m], applied to working oil from the pump wheel 6p, torque T₂ [N·m], applied to working oil from the turbine wheel 6t, and torque T₃ [N·m], applied to working oil from the stator wheel 6s, are given by equations (3) to (5), respectively. In equations (3) to (5), T_{P} is pump torque [N·m], i.e., engine torque; T_{T} is turbine torque [N·m], i.e., output torque; and T_{S} is stator torque [N·m] coincident with the magnitude of reactive torque of the stator wheel 6s, i.e., torque acting on the stator wheel 6s in the positive rotating direction in agreement with the rotating direction of the pump wheel 6p when the flow of working oil is caused to turn in direction by the action of the stator wheel 6s.

T₁=T_{P}=(γ/g)×Q×(V_{UP}×r₂−V_{US}×r₁) Eq. (3)

T₂=−T_{T}=(γ/g)×Q×(V_{UT}×r₃−V_{UP}×r₂) Eq. (4)

T₃=T_{S}=(γ/g)×Q×(V_{US}×r₁−V_{UT}×r₃) Eq. (5)

In equations (3) to (5), “r₁” is a distance [m] from a rotational axis, i.e., the input shaft (turbine shaft) 22 of the automatic transmission 8 to an outlet “bp” of fluid flow in the pump wheel 6p, that is, an inlet “at” of fluid flow in the turbine wheel 6t. “r₂” is a distance [m] from a rotational axis, i.e., the input shaft (turbine shaft) 22 of the automatic transmission 8 to an outlet “bt” of fluid flow in the turbine wheel 6t, that is, an inlet “as” of fluid flow in the stator wheel 6s. “r₃” is a distance [m] from a rotational axis, i.e., the input shaft (turbine shaft) 22 of the automatic transmission 8 to an outlet “bs” of fluid flow in the stator wheel 6s, that is, an inlet “ap” of fluid flow in the pump wheel 6p. In equations (3) to (5), further, V_{UP} is a circumferential velocity component [m/s] of an absolute speed of the pump wheel 6p; V_{UT} is a circumferential velocity component [m/s] of an absolute speed of the turbine wheel 6t; and V_{US} is a circumferential velocity component [m/s] of an absolute speed of the stator wheel 6s.

From equations (3) to (5), T₁+T₂+T₃=0 (Zero) is established and, hence, pump torque T_{P}, turbine torque T_{T} and stator torque T_{S} can be given by equation (6) described below. That is, with the torque converter 6, a torque increment in turbine torque T_{T} relative to pump torque T_{P} coincides with stator torque T_{S}.

T_{T}=T_{P}+T_{S} Eq. (6)

With the torque converter 6 of the present embodiment, the reactive force of the stator wheel 6s is caused to increase or decrease in response to drive torque T_{D} or brake torque T_{B} that are adjusted in the rotation control of the electric motor 10. This allows the turbine wheel to provide output torque that is caused to increase or decrease with respect to output torque obtained by the related art torque converter with a fixed capacity.

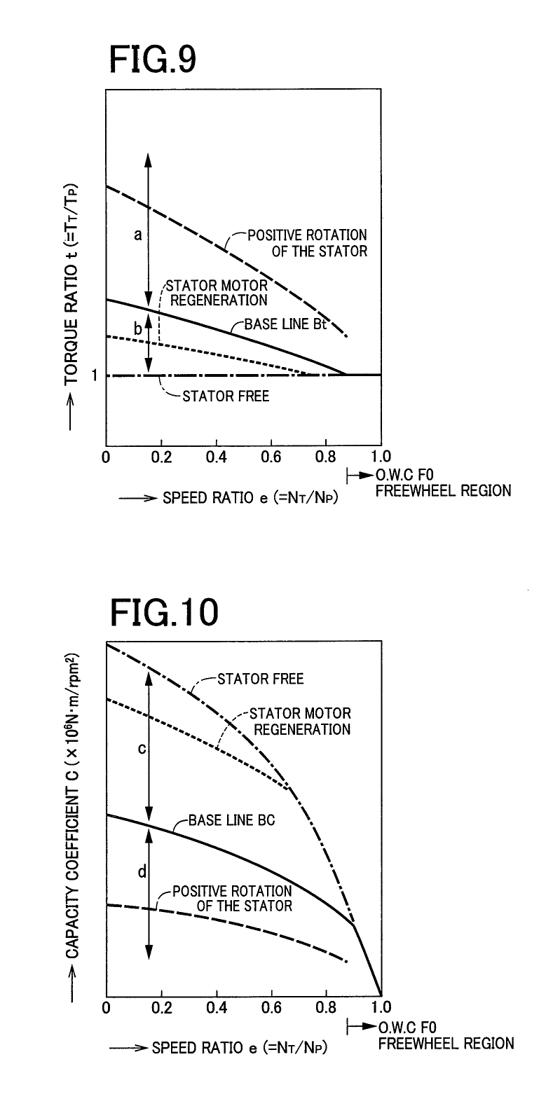

FIGS. 9 and 10 are views showing characteristics of the torque converter 6 of the present embodiment representing the contents described above. FIG. 9 is a view showing a torque ratio (torque multiplying ratio) of “t” (=T_{T}/T_{P}) between turbine torque T_{T} and pump torque T_{P} in terms of a rotational speed ratio between a turbine revolution N_{T} [rpm] of the turbine wheel 6t and a pump revolution N_{P} [rpm] of the pump wheel 6p, i.e., a speed ratio of “e” (=N_{T}/N_{P}). FIG. 10 is a view showing a capacity coefficient C (=N_{T}/N_{P}²) [N·m/rpm²] in terms of e (=N_{T}/N_{P}). As will be apparent from FIGS. 9 and 10, the torque ratio “t” (torque multiplication ratio) and the capacity coefficient C have the relationship remaining in the nearly inverted proportional relationship. With the same speed ratio “e”, the relationship stands in that when the capacity coefficient C is large, the torque ratio “t” is greater than that when the capacity coefficient C is small.

In FIGS. 9 and 10, adjusting brake torque T_{B} to lie at a given value or causing the brake B0 to engage allows the stator wheel 6s to be fixedly secured to the case 11 via the one-way clutch F0. Thus, torque is transferred at a given torque ratio “t” determined on design like the related art torque converter with the fixed capacity as indicated by a baseline Bt plotted on a solid line in FIG. 9. Also, the resulting capacity coefficient C of the torque converter 6 traces a baseline BC indicated by a solid line in FIG. 10.

Further, with the clutch C0 caused to suitably engage, drive torque T_{D} is adjusted with the electric motor 10 at a given value to cause the stator wheel 6s to rotate in the same speed as the pump wheel 6p. This causes stator torque T_{S} to increase such that torque is transferred at a torque ratio “t” greater than that of the related art torque converter with the fixed capacity as indicated by a long broken line in FIG. 9 representing the positive rotation of the stator wheel. The resulting capacity coefficient C of the torque converter 6 varies in a manner as indicated by a long broken line in FIG. 10 representing the stator's positive rotation. Moreover, even with the presence of the same speed ratio “e”, causing the electric motor 10 to further increase or decrease drive torque T_{D} allows the torque ratio “t” and the capacity coefficient C to be suitably determined as indicated by arrows “a” and “d” in FIGS. 9 and 10, respectively. Such determination is made to fall in ranges starting from the baseline Bt, shown in FIG. 9, to an area beyond the long broken line, representing the stator's positive rotation, and starting from the baseline BC, shown in FIG. 10, to another area below the long broken line representing the stator's positive rotation.

Furthermore, when the clutch C0 and the brake B0 are caused to be disengaged and the stator torque T_{S} is caused to be zero, no torque increase occurs as indicated by a single dot line representing a stator free in FIG. 9, under which torque is transferred with a torque ratio t=1. As a result, the torque converter 6 is rendered operative as a fluid coupling device. The resulting capacity coefficient C of the torque converter 6 varies as shown by an alternate long and short dashed line representing the stator free in FIG. 10.

Moreover, with a slippage caused to occur in the brake B0 upon adjusting brake torque T_{B} at a given value or adjusting the engaging pressure of the brake B0 at a given value, stator torque T_{S} will be lower than that of the torque converter with the stator wheel 6s being fixedly secured. This allows torque to be transferred at a torque ratio “t” smaller than that obtained with the related art torque converter with the fixed capacity as indicated by a short broken line representing stator motor regeneration in FIG. 9. The resulting capacity coefficient C of the torque converter 6 traces the short broken line representing the stator motor regeneration in FIG. 10. In addition, even with the presence of the same speed ratio “e”, causing brake torque T_{B} or the engaging pressure of the brake B0 to further increase or decrease allows the torque ratio “t” and the capacity coefficient C to be suitably determined within a range between the baselines Bt or BC, as indicated by arrows “b” and “c” in FIGS. 9 and 10, and the single dot line representing the stator free.

That is, with the present embodiment, the electric motor 10 rotatably controls the stator wheel 6s in the positive rotating direction in agreement with the rotating direction of the pump wheel 6p such that the torque ratio “t” is caused to increase. Further, with the present embodiment, the electric motor 10 rotatably controls the stator wheel 6s in the negative rotating direction opposite to the rotating direction of the pump wheel 6p with a braking (regenerative) effect such that the torque ratio “t” is caused to decrease. Moreover, with the present embodiment, the brake B0 is caused to slip for rotatably controlling the stator wheel 6s in the negative rotating direction opposite to the rotating direction of the pump wheel 6p, thereby achieving a reduction in the torque ratio “t”.

More particularly, the electronic control device 78 performs controls to cause the clutch C0 to engage while permitting the electric motor 10 to rotate the stator wheel 6s to rotate at the same rotation as the pump wheel 6p during startup or accelerated running of the vehicle. This results in effect of controlling the torque converter 6 such that torque ratio “t” increases and the capacity coefficient C decreases as mentioned above. Such an increase in torque ratio “t” results in an increase in startup torque or acceleration torque and the reduction in capacity coefficient C causes the engine rotation to smoothly increase. Such controls are effective for the running mode with directivity for acceleration (power performance) with an increasing accel-opening or the like and particularly effective when executed with a turbocharger engine or the like with the engine rotation being needed to further smoothly increase.

Further, the electronic control device 78 performs controls so as to disengage the brake B0 while causing the clutch C0 to disengage or rendering the electric motor operative under an idle running state during startup or accelerated running of the vehicle. This causes the stator wheel 6s to rotate in a free state with respect to the non-rotating member and the torque converter 6 has the torque ratio “t” of “1” with an increase in capacity coefficient C. Such an increase in capacity coefficient C enables the suppression of an increase in the engine rotation. Such controls are effective for a running mode with directivity for low fuel consumption with a lowered accel-opening or the like.

Furthermore, the electronic control device 78 performs controls so as to disengage the brake B0 while causing the clutch C0 to engage such that the electric motor 10 is caused to rotate with torque acting on the stator wheel 6s during startup or accelerated running of the vehicle. During startup or accelerated running of the vehicle, the torque converter 6 performs torque multiplication. Under such a circumstance, the operation is executed to control the regeneration of the electric motor 10 due to a consequence of the stator wheel 6s caused to rotate in the negative direction of rotation opposite to the rotational direction of the pump wheel 6p resulting from torque, i.e., reaction torque applied by the flow of fluid. This allows the torque converter 6 to be controlled so as to decrease the torque ratio “t” and the capacity coefficient C to be controllably increased. Such controls are effective for the running mode with directivity for low fuel consumption with the lowered accel-opening or the like. In addition, this results in increased fuel economy performance due to the regeneration of the electric motor 10.

Moreover, the electronic control device 78 allows the clutch C0 to usually engage while causing the clutch C0 to slip when applied with rapid torque, i.e., drive torque T_{D} or brake torque T_{B}. This protects the electric motor 10 or the stator wheel 6s controllably rotated therewith. In addition, the clutch C0 is caused to disengage during a failure of the electric motor 10 or during a moment needed to suppress the load of the electric motor in the presence of limited charging and discharging or heat generation. This allows the electric motor 10 to be disconnected from the stator wheel 6s. Further, by operatively causing the brake B0 to engage, the stator wheel 6s can be applied with reaction force without using the electric motor 10 during the failure of the electric motor 10 or during the moment needed to suppress the load of the electric motor in the presence of limited charging and discharging or heat generation.

As set forth above, according to the variable displacement torque converter 6 of the present embodiment, the electric motor (motor) 10 that drivably rotates the stator wheel 6s for the purpose of adjusting output torque delivered from the turbine wheel 6t, i.e., turbine torque T_{T} is comprised. By using the electric motor 10 to actively drive the stator wheel 6s to rotate in the positive direction of rotation in conformity to the rotational direction of the pump wheel 6p, it becomes possible to have a higher torque ratio “t” and a lower capacity coefficient C than those attained in the related art. In addition, using the electric motor 10 to rotate the stator wheel 6s in the positive direction of rotation in conformity to the rotational direction of the pump wheel 6p and in the negative direction of rotation opposite to the rotational direction of the pump wheel 6p allows the torque ratio “t” and the capacity coefficient C to have wider varying ranges than those attained in the related art. This allows the vehicle to have remarkably improved fuel economy performance and power performance.

Further, according to the variable displacement torque converter 6 of the present embodiment, the clutch C0 operative to provide a connection between the electric motor 10 and the stator wheel 6s is further included. This allows the clutch C0 to usually engage while causing the clutch C0 to slip when applied with rapid torque, i.e., drive torque T_{D} or brake torque T_{B}. This protects the electric motor 10 or the stator wheel 6s controllably rotated therewith. In addition, the clutch C0 is caused to disengage during the failure of the electric motor 10 or during the moment needed to suppress the load of the electric motor in the presence of limited charging and discharging or heat generation. This enables the electric motor 10 to be disconnected from the stator wheel 6s.

Besides, according to the variable displacement torque converter 6 of the present embodiment, the brake B0 capable of providing a connection between the stator wheel 6s and the non-rotating member, i.e., the case 11 is further included. By operatively causing the brake B0 to engage, the stator wheel 6s can be applied with reaction force without using the electric motor 10 during the failure of the electric motor 10 or during the moment needed to suppress the load of the electric motor in the presence of limited charging and discharging or heat generation.

According to the variable displacement torque converter 6 of the present embodiment, the electric motor 10 causes the stator wheel 6s to rotate in the positive direction of rotation in conformity to the rotational direction of the pump wheel 6p with a resultant increase in the torque ratio “t”. Thus, it becomes possible to have higher torque ratio “t” and lower capacity coefficient C than those attained in the related art.

According to the variable displacement torque converter 6 of the present embodiment, the electric motor 10 has the regenerative effect to rotate the stator wheel 6s in the negative direction of rotation opposite to the rotational direction of the pump wheel 6p with a resultant decrease in the torque ratio “t”. This allows wider varying ranges to be obtained for the torque ratio “t” to a decreasing side and for the capacity coefficient C to an increasing side. This enables the vehicle to have further remarkably increased fuel economy performance and power performance.

According to the variable displacement torque converter 6 of the present embodiment, the brake B0 is caused to slip such that the stator wheel 6s rotates in the negative direction of rotation opposite to the rotational direction of the pump wheel 6p with a resultant decrease in torque ratio “t”. This results in wider varying ranges for the torque ratio “t” to a decreasing side and for the capacity coefficient for an increasing side. This enables the vehicle to have further remarkably increased fuel economy performance and power performance.

According to the variable displacement torque converter 6 of the present embodiment, the one-way clutch F0 is disposed between the stator wheel 6s and the clutch C0 or the brake B0. This allows the stator wheel 6s to rotate in the positive direction of rotation in conformity to the rotational direction of the pump wheel 6p but blocks the stator wheel 6s from rotating in the negative direction of rotation opposite to the rotational direction of the pump wheel 6p. This results in an effect of obtaining a certain torque converter characteristic like that of a fixed-displacement torque converter of the related art even during the failure of the electric motor 10 or during the moment needed to suppress the load of the electric motor in the presence of limited charging and discharging or heat generation.

While one embodiment of the present invention has been described above with reference to the accompanying drawings, the present invention is not limited to such an embodiment and may be implemented in other modes.

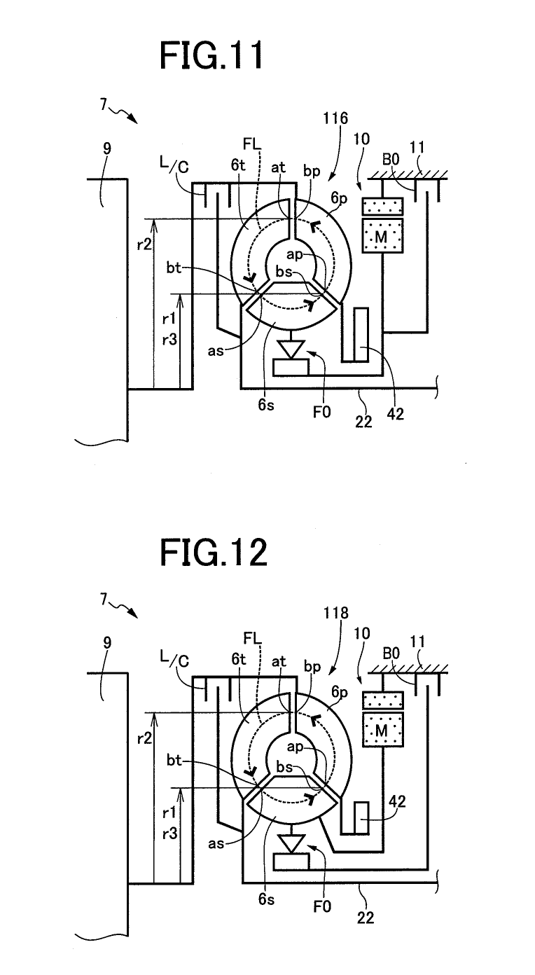

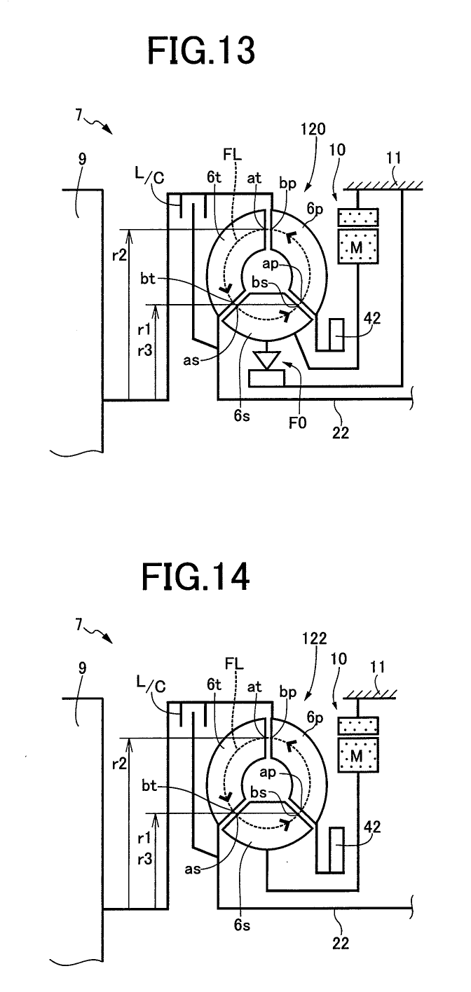

With the embodiment described above, for instance, it doesn't matter if a part of or a whole of the brake B0, the clutch C0 and the one-way clutch F0 are not provided. For instance, a torque converter 116, exemplified in FIG. 11, takes a structure wherein the clutch C0 between the electric motor 10 and the stator wheel 6s is removed. A torque converter 118, exemplified in FIG. 12, is structured wherein the clutch C0 between the electric motor 10 and the stator wheel 6s is removed with the electric motor 10 being directly connected to the stator wheel 6s. A torque converter 120, exemplified in FIG. 13, is structured wherein the clutch C0 between the electric motor 10 and the stator wheel 6s and the brake B0 between the housing 11 and the stator wheel 6s are removed with the electric motor 10 being directly connected to the stator wheel 6s. A torque converter 122, exemplified in FIG. 14, is structured wherein the brake B0, the clutch C0 and the one-way clutch F0 are removed with the electric motor 10 being directly connected to the stator wheel 6s.

While the embodiment has been described above with reference to the vehicle having the automatic transmission 8 in longitudinal geometry that can be preferably adopted in an FR (Front Engine and Rear Drive) vehicle, the present invention is not limited to such an application and may be applied to vehicles having an automatic transmission in transverse geometry or the other various driving systems.

It is intended that the embodiments described be considered only as illustrative of the present invention and that the present invention may be implemented in various modifications and improvements in the light of knowledge of those skilled in the art.

1. A variable displacement torque converter having a pump wheel rotatably driven to generate a flow of fluid, a turbine wheel rotated in response to the flow of fluid delivered from the pump wheel, and a stator wheel rotatably disposed in the flow of fluid from the turbine wheel to the pump wheel, the variable displacement torque converter comprising:
an electric motor rotatably driving the stator wheel for adjusting an output torque to be output from the turbine wheel.

2. The variable displacement torque converter according to claim 1, further comprising a clutch connectable between the electric motor and the stator wheel.

3. The variable displacement torque converter according to claim 1, further comprising a brake connectable between the stator wheel and a non-rotating member.

4. The variable displacement torque converter according to claim 1, wherein the electric motor causes the stator wheel to rotate in a positive direction of rotation in conformity to a rotational direction of the pump wheel so that a torque multiplying ratio is increased.

5. The variable displacement torque converter according to claim 1, wherein the electric motor performs regeneration to cause the stator wheel to rotate in a negative direction of rotation opposite to the rotational direction of the pump wheel so that a torque multiplying ratio is decreased.

6. The variable displacement torque converter according to claim 3, wherein the brake is caused to slip to allow the stator wheel to rotate in a negative direction of rotation opposite to the rotational direction of the pump wheel so that a torque multiplying ratio is decreased.

7. The variable displacement torque converter according to claim 2, further comprising a one-way clutch disposed between the stator wheel and the clutch or the brake for permitting the stator wheel to rotate in a positive direction of rotation in conformity to the rotational direction of the pump wheel but blocking the stator wheel from rotating in a negative direction of rotation opposite to the rotational direction of the pump wheel.
